(19) United States
(12) Patent Application Publication
(10) Pub. No.: US 2020/0191001 A1
(43) Pub. Date: Jun. 18, 2020

(54) LEADING EDGE COVER MEMBER, LEADING EDGE COVER MEMBER UNIT, COMPOSITE BLADE, METHOD OF MANUFACTURING LEADING EDGE COVER MEMBER, AND METHOD OF MANUFACTURING COMPOSITE BLADE

(71) Applicant: MITSUBISHI HEAVY INDUSTRIES, LTD., Tokyo (JP)

(72) Inventors: Ryoji OKABE, Tokyo (JP); Kentaro SHINDO, Tokyo (JP); Masami Kamiya, Tokyo (JP); Makoto INOMOTO, Tokyo (JP)

(21) Appl. No.: 16/618,237

(22) PCT Filed: Feb. 26, 2019
(86) PCT No.: PCT/JP2019/007353

§ 371 Date: Nov. 29, 2019

(30) Foreign Application Priority Data
Mar. 9, 2018 (JP) 2018-042939

(51) Int. Cl. F01D 5/28; F01D 5/14

(52) U.S. Cl. CPC F01D 5/282; F04D 29/321; F01D 5/147

(57) ABSTRACT

A leading edge cover member is provided on an outside of a leading edge area including a leading edge serving as a part on an airflow upstream side of a composite blade body containing reinforcement fibers and a resin. The leading edge cover member includes a composite cover base material that contains reinforcement fibers and a resin, and is provided to the outside of the leading edge area in a bonding manner; and a metallic reinforcement layer formed on at least a part of an outside of the composite cover base material.

### FIELD

The present invention relates to a leading edge cover member, a leading edge cover member unit, a composite blade, a method of manufacturing the leading edge cover member, and a method of manufacturing the composite blade.

### BACKGROUND

Blades and vanes are made using composite blade bodies and vane bodies formed by laying up composite layers in which reinforcement fibers are impregnated with a resin. For example, for a composite blade body used in a fan blade of an aircraft engine, a structure has been developed in which a leading edge cover member of a thick metal is bonded to a leading edge area including a leading edge in consideration of, for example, a bird strike and collision of, for example, a cloud of sand (refer, for example, to Patent Literature 1).

### CITATION LIST

### Patent Literature

Patent Literature 1: Japanese Patent Application Laid-open No. 2016-138550

### SUMMARY

### Technical Problem

A composite blade body used in an industrial gas turbine compressor is sometimes sprayed with water droplets in order to reduce intake-air temperature. Accordingly, a countermeasure needs to be taken against water droplet erosion. Metallic materials, such as a titanium alloy, having high corrosion resistivity and high fatigue strength are suitable for the countermeasure against the water droplet erosion. However, since such metallic materials, such as a titanium alloy, are processing resistant materials, a problem arises that the materials are difficult to be processed so as to match a shape of a thin and complicatedly curved leading edge area included in the composite blade body used in the industrial gas turbine compressor. Accordingly, when the method of Patent Literature 1 is used to manufacture the leading edge cover member suitable to be used in the composite blade body used in the industrial gas turbine compressor as the countermeasure against the water droplet erosion, problems arise in manufacturability and manufacturing cost.

An energy of collision of the water droplets received by the composite blade body used in the industrial gas turbine compressor is much smaller than an energy of the bird strike or the collision of, for example, the cloud of sand received by the composite blade body used in the fan blade of the aircraft engine. Accordingly, when the method of Patent Literature 1 is used to manufacture the leading edge cover member suitable to be used in the composite blade body used in the industrial gas turbine compressor as the countermeasure against the water droplet erosion, the leading edge cover member is overdesigned in terms of strength against the collision. Accordingly, a problem arises that the composite blade body used in the industrial gas turbine compressor may lose an advantage of lightness of weight.

The present invention has been made in view of the above, and it is an object thereof to provide a leading edge cover member, a leading edge cover member unit, and a composite blade that are suitable to be used for the composite blade body used in the industrial gas turbine compressor as the countermeasure against the water droplet erosion, a method of manufacturing the leading edge cover member, and a method of manufacturing the composite blade.

### Solution to Problem

To solve the problems described above and achieve the object, a leading edge cover member is provided on an outside of a leading edge area including a leading edge serving as a part on an airflow upstream side of a composite blade body containing reinforcement fibers and a resin. The leading edge cover member includes a composite cover base material that contains reinforcement fibers and a resin, and is provided to the outside of the leading edge area in a bonding manner; and a metallic reinforcement layer formed on at least a part of an outside of the composite cover base material.

With this configuration, a part on a side of the leading edge cover member provided to the leading edge area of the composite blade body in a bonding manner can be constituted by the composite material that is lightweight and has good workability, and the outside part of the leading edge cover member serving as the part on the airflow upstream side thereof can be constituted by the metal that has high corrosion resistivity and high fatigue strength. Accordingly, the leading edge cover member can be obtained that is suitable to be used for the composite blade body used in the industrial gas turbine compressor as the countermeasure against the water droplet erosion.

In this configuration, it is preferable that the composite cover base material has a thickness at a ratio of 2% to 30% inclusive with respect to a leading edge radius of the composite blade body or half the minor axis of the composite blade body over the whole blade length of the composite blade body, and the metallic reinforcement layer has a thickness of 5 μm to 100 μm inclusive. With this configuration, the leading edge cover member can be obtained that is more lightweight, and fits well with the leading edge area of the composite blade body.

In these configurations, it is preferable that the thickness of the metallic reinforcement layer is equal to or smaller than the thickness of the composite cover base material. With this configuration, stiffness is balanced between the composite cover base material and the metallic reinforcement layer, and therefore, the leading edge cover member can be obtained that can reduce the likelihood of a situation in which one of the composite cover base material and the metallic reinforcement layer is deformed by the other thereof.

In these configurations, it is preferable that, in the composite cover base material, the reinforcement fibers contained in the composite cover base material are arranged along a direction of 30 degrees to 60 degrees inclusive with respect to a blade longitudinal direction of the composite blade body. This configuration allows the reinforcement fibers contained in the composite cover base material to be easily deformed along the leading edge area of the composite blade body. Accordingly, the leading edge cover member can be obtained that fits better with the leading edge area of the composite blade body.

In these configurations, it is preferable that the composite cover base material is formed by laying up thin-film prepregs of a carbon fiber reinforced plastic or a glass fiber reinforced plastic. Alternatively, in these configurations, it is preferable that, in the composite cover base material, the reinforcement fibers contained in the composite cover base material are high-modulus resin fibers. These configurations allow the composite cover base material to be lightweight and easily deformed along the leading edge area of the composite blade body. Accordingly, the lightweight leading edge cover member can be obtained that fits better with the leading edge area of the composite blade body.

In these configurations, it is preferable that an electrically insulative electrical insulation layer is included which is provided so as to be in contact with a surface on a side of the composite cover base material on which the metallic reinforcement layer is provided. In addition, it is more preferable that the electrical insulation layer is an insulating fiberglass reinforced plastic layer. These configurations can restrain the metallic reinforcement layer from electrically corroding.

In these configurations, it is preferable that the metallic reinforcement layer includes a hard metallic reinforcement layer that is provided on a surface side of the metallic reinforcement layer and is formed of a hard metal or a superhard metal. In addition, it is more preferable that the hard metallic reinforcement layer is a hard chromium (Cr) plating layer or a nickel (Ni) alloy plating layer. These configurations can reduce the amount of wear caused by the collision of the water droplets while hardly affecting the degree of fitness with the leading edge area.

In these configurations, it is preferable that the metallic reinforcement layer includes an auxiliary metallic reinforcement layer formed of a soft metal that is provided so as to be in contact with a surface on a side of the metallic reinforcement layer on which the composite cover base material is provided. In addition, it is preferable that the auxiliary metallic reinforcement layer is a copper (Cu) plating layer or a pure Ni plating layer. With these configurations, the auxiliary metallic reinforcement layer is soft and highly ductile.

Accordingly, a shear strain generated on a boundary surface between the composite cover base material and the metallic reinforcement layer is reduced, and thereby, an adhesive strength can increase between the composite cover base material and the metallic reinforcement layer.

In these configurations, it is preferable that a boundary surface on the metallic reinforcement layer side of the composite cover base material has an arithmetic mean roughness value of 1 μm to 10 μm inclusive. With this configuration, the arithmetic mean roughness of the boundary surface between the composite cover base material and the metallic reinforcement layer can increase the adhesive strength between the composite cover base material and the metallic reinforcement layer.

Alternatively, in these configurations, it is preferable that a primer layer containing palladium catalytic particles is formed on a boundary surface on the metallic reinforcement layer side of the composite cover base material. With this configuration, the primer layer can increase the adhesive strength between the composite cover base material and the metallic reinforcement layer, and, in addition, the aerodynamic performance of a composite blade can be improved by smoothing of the metallic reinforcement layer.

In these configurations, it is preferable that an outer surface of a boundary between the composite cover base material and the metallic reinforcement layer is formed as a smooth surface without any step. This configuration can restrain the composite blade from decreasing in aerodynamic efficiency.

To solve the problems described above and achieve the object, a leading edge cover member unit includes any one of the leading edge cover members described above; and a male die that is provided, on an outside thereof, with the leading edge cover member, and has a shape of the leading edge area of the composite blade body. This configuration allows the leading edge cover member unit to be handled, for example, carried, while appropriately maintaining the shape of the leading edge cover member using the male die.

To solve the problems described above and achieve the object, a composite blade includes any one of the leading edge cover members described above; and the composite blade body provided, on the outside of the leading edge area thereof, with the leading edge cover member. With this configuration, the part on the side of the leading edge cover member provided to the leading edge area of the composite blade body in a bonding manner can be constituted by the composite material that is lightweight and has good workability, and the outside part of the leading edge cover member serving as the part on the airflow upstream side thereof can be constituted by the metal that has high corrosion resistivity and high fatigue strength. Accordingly, the composite blade can be obtained in which the composite blade body used in the industrial gas turbine compressor is provided with the appropriate countermeasure against the water droplet erosion.

In this configurations, it is preferable that an outer surface of a boundary between the composite blade body and the leading edge cover member is formed as a smooth surface without any step. This configuration can restrain the composite blade from decreasing in aerodynamic efficiency.

To solve the problems described above and achieve the object, a method is of manufacturing a leading edge cover member provided on an outside of a leading edge area including a leading edge serving as a part on an airflow upstream side of a composite blade body. The method includes: a composite cover base material forming step of forming a composite cover base material of a leading edge cover member by laying up prepregs containing reinforcement fibers and a resin on a male die having a shape of the leading edge area of the composite blade body, and curing the laid-up prepregs; and a metallic reinforcement layer forming step of forming the leading edge cover member by forming a metallic reinforcement layer on at least a part of an outside of the composite cover base material that has been formed at the composite cover base material forming step. With this configuration, the part on the side of the leading edge cover member provided to the leading edge area of the composite blade body in a bonding manner can be constituted by the composite material that is lightweight and has good workability, and the outside part of the leading edge cover member serving as the part on the airflow upstream side thereof can be constituted by the metal that has high corrosion resistivity and high fatigue strength. Accordingly, the leading edge cover member can be obtained that is suitable to be used for the composite blade body used in the industrial gas turbine compressor as the countermeasure against the water droplet erosion.

To solve the problems described above and achieve the object, a method of manufacturing a composite blade includes: the composite cover base material forming step and the metallic reinforcement layer forming step in the above-described method of manufacturing a leading edge cover member; and a bonding step of fitting and bonding the leading edge cover member with the metallic reinforcement layer formed thereon to the composite blade body. With this configuration, the part on the side of the leading edge cover member provided to the leading edge area of the composite blade body in a bonding manner can be constituted by the composite material that is lightweight and has good workability, and the outside part of the leading edge cover member serving as the part on the airflow upstream side thereof can be constituted by the metal that has high corrosion resistivity and high fatigue strength.

Accordingly, the composite blade can be obtained in which the composite blade body used in the industrial gas turbine compressor is provided with the appropriate countermeasure against the water droplet erosion.

### BRIEF DESCRIPTION OF DRAWINGS

FIG. 1 is a schematic perspective view of a leading edge cover member and a composite blade according to an embodiment of the present invention.

FIG. 2 is a sectional view illustrating an example of a detailed configuration of the leading edge cover member and the composite blade according to the embodiment.

FIG. 3 is an enlarged view obtained by enlarging an area A in FIG. 2.

FIG. 4 is a graph illustrating characteristics of a metallic reinforcement layer in FIG. 2.

FIG. 5 is a sectional view illustrating another example of the detailed configuration of the leading edge cover member and the composite blade according to the embodiment.

FIG. 6 is a sectional view illustrating still another example of the detailed configuration of the leading edge cover member and the composite blade according to the embodiment.

FIG. 7 is a flowchart illustrating a method of manufacturing the leading edge cover member and the composite blade according to the embodiment.

FIG. 8 is an explanatory diagram explaining a composite cover base material forming step in FIG. 7.

FIG. 9 is an explanatory diagram explaining one stage of a metallic reinforcement layer forming step in FIG. 7.

FIG. 10 is an explanatory diagram explaining the next one stage of the metallic reinforcement layer forming step in FIG. 7.

FIG. 11 is an explanatory diagram explaining a bonding step in FIG. 7.

### DESCRIPTION OF EMBODIMENTS

The following describes an embodiment of the present invention in detail based on the drawings. The embodiment does not limit the present invention.

Components in the embodiment include those replaceable and easily constituted by those skilled in the art, or those substantially identical thereto. Furthermore, the components described below can be combined with one another as appropriate.

### EMBODIMENT

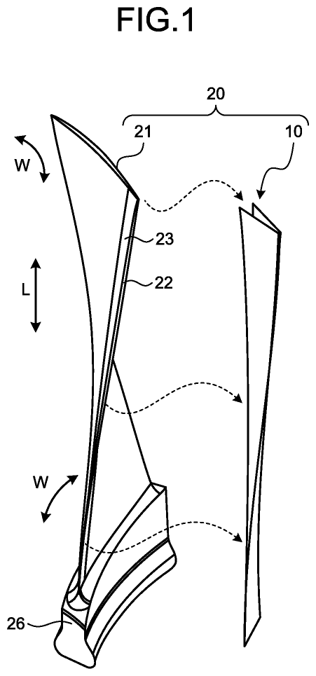

FIG. 1 is a schematic perspective view of a leading edge cover member 10 and a composite blade 20 according to an embodiment of the present invention. As illustrated in FIG. 1, the composite blade 20 includes the leading edge cover member 10 and a composite blade body 21 provided with the leading edge cover member 10 on the outside of a leading edge area 23 that includes a leading edge 22. The leading edge area 23 refers to an area that resides within a constant distance from the leading edge 22 in a direction intersecting the leading edge 22, the distance covering parts of surfaces of a suction side and a pressure side adjacent to the leading edge 22 and located across the leading edge 22, and that resides within a range of at least a part or the whole of the length of the leading edge 22 in a direction along the leading edge 22. Examples of the composite blade 20 include that used in an industrial gas turbine compressor.

The composite blade body 21 is formed by, for example, laying up composite layers in a blade thickness direction that is a direction connecting the suction side to the pressure side of the composite blade body 21. A direction L illustrated in FIG. 1 corresponds to a blade longitudinal direction that is a direction connecting a blade tip side to a blade root side of the composite blade body 21. A direction W illustrated in FIG. 1 corresponds to a blade width direction that is a direction connecting a leading edge side to a trailing edge side of the composite blade body 21. The suction side and the pressure side of the composite blade body 21 are each formed of a complicated curved surface, and the direction W on the blade tip side and the direction W on the blade root side has a twisted relationship. Of the two curved lines serving as lines of intersection between the curved surface on the suction side and the curved surface on the pressure side of the composite blade body 21, a curved line on an airflow upstream side corresponds to the leading edge 22, and a curved line on an airflow downstream side corresponds to the trailing edge. The composite blade body 21 is fixed, at an end on the blade root side thereof, to a circumferential surface of a rotary shaft by a composite blade support member 26 so as to be supported rotatably at a predetermined radius in a predetermined direction.

The leading edge cover member 10 contains a composite material, and is provided to an outer surface of the leading edge area 23 in a bonding manner so as to cover the leading edge area 23, as illustrated in FIG. 1. The composite material contained in the leading edge cover member 10 and the composite blade body 21 includes reinforcement fibers and a resin with which the reinforcement fibers are impregnated. Examples of this composite material include materials generally used in, for example, aircraft, automobiles, and ships. Examples of the reinforcement fibers include those obtained by bundling several hundred to several thousand base fibers of 5 μm to 7 μm inclusive. Examples of preferable base fibers constituting the reinforcement fibers include glass fibers, carbon fiber, and aramid fibers. The base fibers constituting the reinforcement fibers are not limited to these examples, and may be other glass fibers, plastic fibers, or metallic fibers.

The resin with which the reinforcement fibers are impregnated is preferably a thermosetting resin, but may be a thermoplastic resin. Examples of the thermosetting resin include an epoxy resin, a polyester resin, and a vinyl ester resin. Examples of the thermoplastic resin include a polyamide resin, a polypropylene resin, an acrylonitrile butadiene styrene (ABS) resin, a polyether ether ketone (PEEK), a polyether ketone ketone (PEKK), and a polyphenylene sulfide (PPS). However, the resin with which the reinforcement fibers are impregnated is not limited to these examples, and may be other resins.

When the resin with which the reinforcement fibers are impregnated is a thermosetting resin, the thermosetting resin can be in a softened state, a cured state, or a semi-cured state. The softened state is a state before the thermosetting resin is thermally cured.

The softened state is a state in which the thermosetting resin does not have a self-supporting property, that is, a state in which the thermosetting resin cannot maintain a shape thereof without being supported by a support. The softened state is a state in which the thermosetting resin can undergo a thermal curing reaction by being heated. The cured state is a state after the thermosetting resin is thermally cured. The cured state is a state in which the thermosetting resin has the self-supporting property, that is, a state in which the thermosetting resin can maintain the shape thereof without being supported by the support. The cured state is a state in which the thermosetting resin cannot undergo the thermal curing reaction by being heated.

The semi-cured state is a state between the softened state and the cured state. The semi-cured state is a state in which the thermosetting resin is thermally cured to a degree lower than that of the cured state. The semi-cured state is a state in which the thermosetting resin has the self-supporting property, that is, a state in which the thermosetting resin can maintain the shape thereof without being supported by the support. The semi-cured state is a state in which the thermosetting resin can undergo the thermal curing reaction by being heated. Hereinafter, a prepreg denotes an intermediate base material made of the composite material obtained by impregnating the reinforcement fibers, such as the carbon fiber, with the thermosetting resin before being cured.

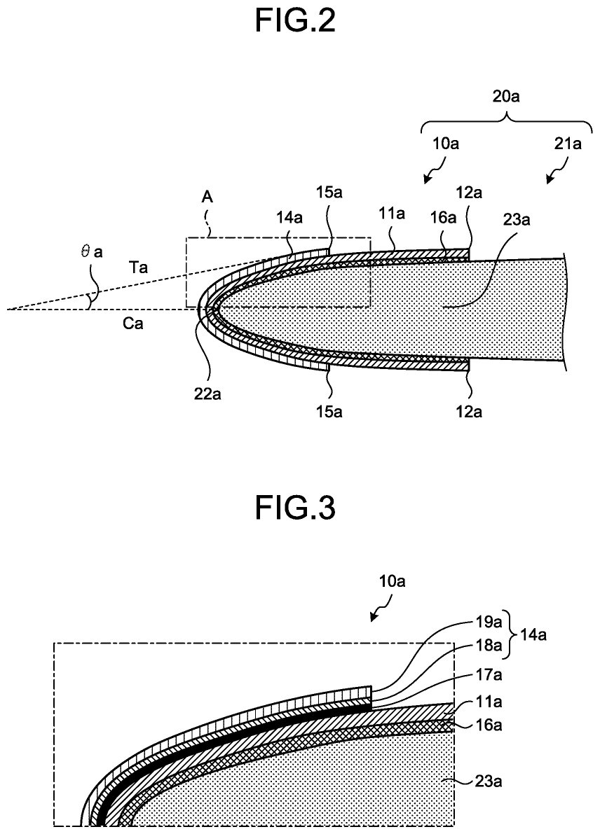

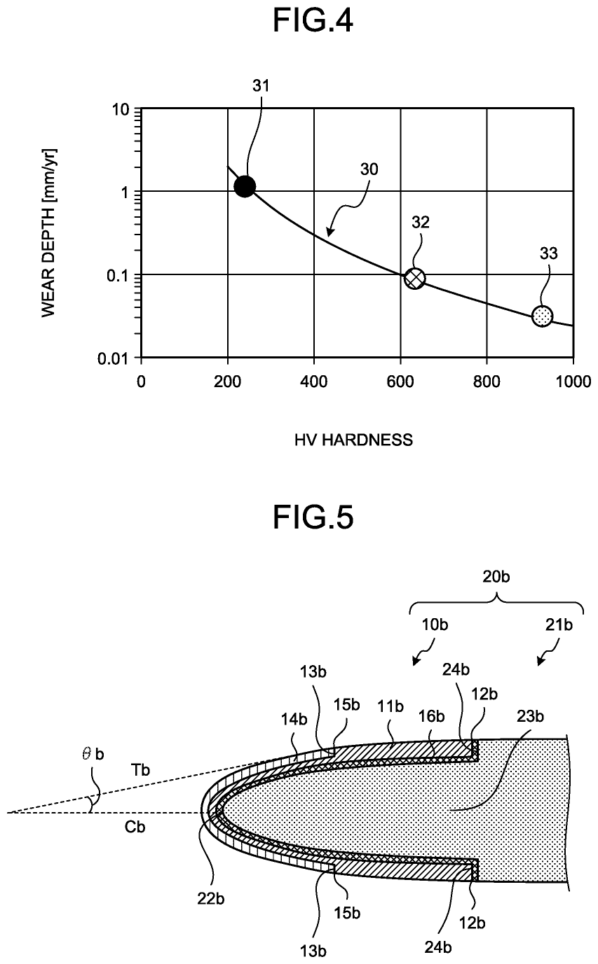

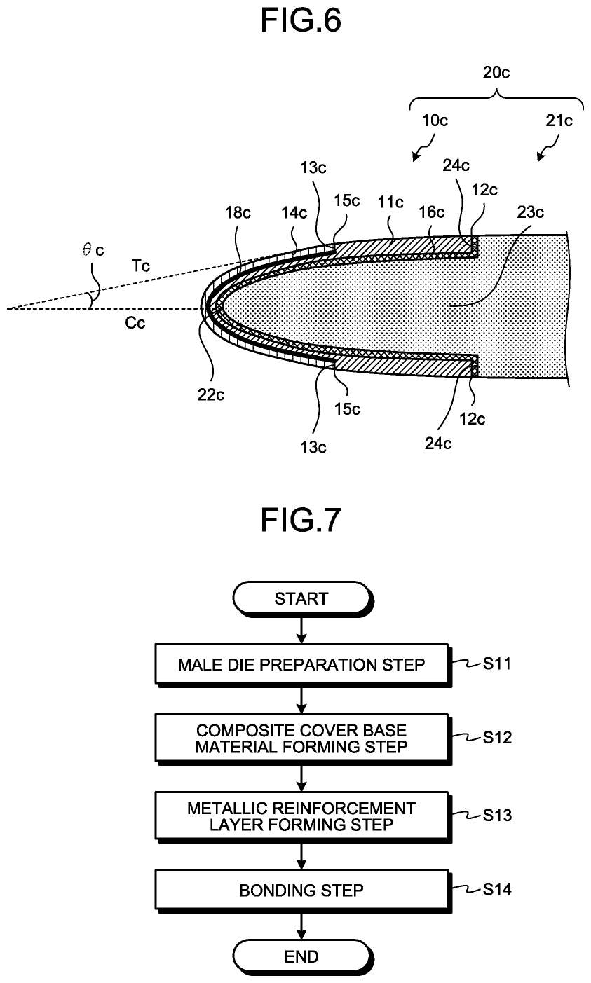

FIG. 2 is a sectional view illustrating an example of a detailed configuration of the leading edge cover member 10 and the composite blade 20 according to the embodiment. FIG. 3 is an enlarged view obtained by enlarging an area A in FIG. 2. FIG. 4 is a graph illustrating characteristics of a metallic reinforcement layer 14a in FIG. 2. FIG. 5 is a sectional view illustrating another example of the detailed configuration of the leading edge cover member 10 and the composite blade 20 according to the embodiment. FIG. 6 is a sectional view illustrating still another example of the detailed configuration of the leading edge cover member 10 and the composite blade 20 according to the embodiment. FIGS. 2, 3, 5, and 6 are all sectional views in a plane along a direction orthogonal to a curved line of the leading edge 22. The following describes the detailed configuration examples of the leading edge cover member 10 and the composite blade 20, using FIGS. 2, 3, 4, 5, and 6.

As illustrated in FIG. 2, a composite blade 20a serving as a first example of the detailed configuration examples of the composite blade 20 includes a leading edge cover member 10a serving as a first example of the detailed configuration examples of the leading edge cover member 10 and a composite blade body 21a serving as a first example of the detailed configuration examples of the composite blade body 21. The composite blade body 21a is provided with the leading edge cover member 10a on the outside of a leading edge area 23a that includes a leading edge 22a. The leading edge 22a and the leading edge area 23a correspond to first examples of the detailed configuration examples of the leading edge 22 and the leading edge area 23, respectively. As illustrated in FIG. 2, the leading edge cover member 10a includes a composite cover base material 11a that contains the composite material and is provided to the outside of the leading edge area 23a in a bonding manner, and also includes the metallic reinforcement layer 14a formed on at least a part of the outside of the composite cover base material 11a.

As illustrated in FIG. 2, the composite blade 20a further includes an adhesive layer 16a that is provided between the leading edge cover member 10a and the leading edge area 23a and bonds the leading edge cover member 10a to the leading edge area 23a. While a normal temperature hardening adhesive or a thermoset adhesive may be used for the adhesive layer 16a, the thermoset adhesive is preferably used if the resin of the leading edge cover member 10a adheres to the leading edge area 23a in the semi-cured state. In the present embodiment, the composite blade 20a includes the adhesive layer 16a. However, the present invention is not limited to this configuration. For example, the configuration may be such that the composite blade 20a does not include the adhesive layer 16a because the resin contained in the leading edge cover member 10a or the leading edge area 23a is used for bonding the leading edge cover member 10a to the leading edge area 23a. The configuration may also be such that the composite blade 20a does not explicitly include the adhesive layer 16a because an adhesive having the same components as those of the resin contained in the leading edge cover member 10a or the leading edge area 23a is used for bonding the leading edge cover member 10a to the leading edge area 23a.

The composite cover base material 11a is formed by, for example, laying up composite layers in the blade thickness direction and being bent in a position facing the leading edge 22a. As illustrated in FIG. 2, the composite cover base material 11a is provided so as to extend across the leading edge 22a in a direction intersecting the leading edge 22a. In detail, the composite cover base material 11a is provided such that, in a section along a direction orthogonal to a curved line of the leading edge 22a, an angle of a direction of a tangent line at an end part 12a of the composite cover base material 11a in a direction intersecting the leading edge 22a is from 0 degrees to 15 degrees inclusive with respect to a direction Ca in which the leading edge 22a is directed. The composite cover base material 11a is provided having at least a part or the whole of the length of the leading edge 22a in a direction along the leading edge 22a.

The metallic reinforcement layer 14a is formed by, for example, metallic plating on at least a part of the outside of the composite cover base material 11a. As illustrated in FIG. 2, the metallic reinforcement layer 14a is provided so as to extend across the leading edge 22a by a width smaller than that of the composite cover base material 11a in the direction intersecting the leading edge 22a. In detail, as illustrated in FIG. 2, the metallic reinforcement layer 14a is provided such that, in the section along the direction orthogonal to the curved line of the leading edge 22a, an angle θa of a direction of a tangent line Ta at an end part 15a of the metallic reinforcement layer 14a in the direction intersecting the leading edge 22a is from 15 degrees to 60 degrees inclusive with respect to the direction Ca in which the leading edge 22a is directed. The metallic reinforcement layer 14a is provided having a length equal to or smaller than that of the composite cover base material 11a in the direction along the leading edge 22a. In this case, the metallic reinforcement layer 14a is provided in a range appropriate for a countermeasure against water droplet erosion, and accordingly, the leading edge cover member 10a and the composite blade 20a can be suitably provided with the countermeasure against the water droplet erosion while desirably maintaining a light-weight state.

The composite cover base material 11a preferably has a thickness at a ratio of 2% to 30% inclusive with respect to a leading edge radius of the composite blade body 21a or half the minor axis of the composite blade body 21a over the whole blade length of the composite blade body 21a. The metallic reinforcement layer 14a preferably has a thickness of 5 μm to 100 μm inclusive. In these cases, the leading edge cover member 10a and the composite blade 20a are more lightweight, and the leading edge cover member 10a fits well with the leading edge area 23a of the composite blade body 21a.

The thickness of the metallic reinforcement layer 14a is preferably equal to or smaller than the thickness of the composite cover base material 11a. In this case, in the leading edge cover member 10a and the composite blade 20a, stiffness is balanced between the composite cover base material 11a and the metallic reinforcement layer 14a, and therefore can reduce the likelihood of a situation in which one of the composite cover base material 11a and the metallic reinforcement layer 14a is deformed by the other thereof.

In the composite cover base material 11a, the reinforcement fibers contained in the composite cover base material 11a are preferably arranged along a direction of 30 degrees to 60 degrees inclusive, and more preferably arranged along a direction of 45 degrees, with respect to the blade longitudinal direction of the composite blade body 21a. The range of the expression “arranged along a direction of 45 degrees” includes a range of an error of ±5 degrees with 45 degrees at the center of the range. In this case, in the leading edge cover member 10a and the composite blade 20a, the number of places can be reduced where the reinforcement fibers contained in the composite cover base material 11a are greatly bent because of being orthogonal to the curved line of the leading edge 22a, so that the reinforcement fibers contained in the composite cover base material 11a can be easily deformed along the leading edge area 23a. As a result, the leading edge cover member 10a fits better with the leading edge area 23a of the composite blade body 21a. In particular, in the leading edge cover member 10a and the composite blade 20a, as the curved surfaces are more complicated on the suction side and the pressure side forming the composite blade body 21a, in other words, as the twist is greater between the blade width direction on the blade tip side and the blade width direction on the blade root side, a more significant effect of the well-fitting of the leading edge cover member 10a with the leading edge 22a is obtained by setting the angle of the reinforcement fibers contained in the composite cover base material 11a within the above-described range.

The composite cover base material 11a is preferably formed by laying up thin-film prepregs of a carbon fiber reinforced plastic (CFRP) or a glass fiber reinforced plastic (GFRP). The thin-film prepregs of the carbon fiber reinforced plastic or the glass fiber reinforced plastic having a thickness of 20 μm to 100 μm inclusive are preferably used. In such a case, in the leading edge cover member 10a and the composite blade 20a, each of the thin-film prepregs is lightweight and can be easily deformed, so that the composite cover base material 11a is lightweight and can be easily deformed along the leading edge area 23a of the composite blade body 21a, and therefore, fits better with the leading edge area 23a of the composite blade body 21a.

Alternatively, in the composite cover base material 11a, the reinforcement fibers contained in the composite cover base material 11a are preferably high-modulus resin fibers, such as aromatic polyamide resin fibers that are called Kevlar (registered trademark) or high-strength polyarylate fibers that are called Vectran (registered trademark). In such a case, in the leading edge cover member 10a and the composite blade 20a, high-modulus resin fibers are lightweight and can be easily deformed, so that the composite cover base material 11a is lightweight and can be easily deformed along the leading edge area 23a of the composite blade body 21a, and therefore, fits better with the leading edge area 23a of the composite blade body 21a.

As illustrated in FIG. 3, the leading edge cover member 10a preferably includes an electrical insulation layer 17a with an electrically insulative property provided so as to be in contact with a surface on a side of the composite cover base material 11a on which the metallic reinforcement layer 14a is provided. In addition, the electrical insulation layer 17a is more preferably an insulating fiberglass reinforced plastic layer. In such a case, in the leading edge cover member 10a and the composite blade 20a, since the electrical insulation layer 17a electrically insulates between the composite cover base material 11a and the metallic reinforcement layer 14a, the metallic reinforcement layer 14a is restrained from serving as an electrode and thereby electrically corroding.

The metallic reinforcement layer 14a is made of a metal having high corrosion resistivity and high fatigue strength. The metallic reinforcement layer 14a has the characteristics in which Vickers hardness (HV) and a wear depth are represented by a curve 30 in the graph in FIG. 4. In other words, the metallic reinforcement layer 14a has a tendency that the wear depth decreases as the HV hardness increases. In the graph in FIG. 4, the horizontal axis represents the HV hardness, and the vertical axis represents the wear depth, where the unit of the wear depth is mm/yr. The unit mm/yr of the wear depth denotes the wear depth (mm) per year.

When a soft metal is used, as illustrated in the graph in FIG. 4, the metallic reinforcement layer 14a has a characteristic represented in a region on the left side of the vicinity of a point 31 on the curve 30; that is, the HV hardness is from 30 to 300 inclusive, and the wear depth is from 1 mm/yr to 10 mm/yr inclusive. Examples of the soft metal used in the metallic reinforcement layer 14a include a copper (Cu) plating layer formed in a layered manner by a copper (Cu) plating process and a pure nickel (Ni) plating layer having a relatively low hardness value formed in a layered manner by a high-purity pure nickel (Ni) plating process. When a hard metal is used, the metallic reinforcement layer 14a has a characteristic represented in the vicinity of a point 32 on the curve 30; that is, the HV hardness is a higher value of 500 to 800 inclusive than that of the soft metal, and the wear depth is from 0.04 mm/yr to 0.2 mm/yr inclusive. Examples of such a layer include a nickel (Ni) alloy plating layer formed in a layered manner by a nickel (Ni) alloy plating process. For example, nickel (Ni)-phosphorus (P) plating, nickel (Ni)-boron (B) plating, and nickel (Ni)-tungsten (W) plating are suitably applicable as the nickel alloy plating. Since electroless plating is applicable as the nickel alloy plating, the electroless plating can be applied to form a layer at an even film thickness even on a surface having a shape with a narrow and deep opening. When a superhard metal is used, the metallic reinforcement layer 14a has a characteristic represented in the vicinity of a point 33 on the curve 30; that is, the HV hardness is a higher value of 800 to 1200 inclusive than that of the hard metal, and the wear depth is from 0.01 mm/yr to 0.04 mm/yr inclusive. Examples of the superhard metal used in the metallic reinforcement layer 14a include a hard chromium (Cr) plating layer formed in a layered manner by a hard chromium (Cr) plating process.

As illustrated in FIG. 3, the metallic reinforcement layer 14a preferably includes a hard metallic reinforcement layer 19a that is provided on a surface side of the metallic reinforcement layer 14a and is formed of the hard metal or the superhard metal. In addition, the hard metallic reinforcement layer 19a is more preferably the hard Cr plating layer or the Ni alloy plating layer.

In such a case, in the leading edge cover member 10a and the composite blade 20a, the wear depth of the hard metallic reinforcement layer 19a provided on the leading edge area 23a is a very small value of 0.2 mm/yr or smaller. Accordingly, when the leading edge cover member 10a and the composite blade 20a are used in the industrial gas turbine compressor, the leading edge area 23a can be reduced in the amount of wear caused by the collision of the water droplets associated with the water droplet spray toward the composite blade body 21a performed to reduce the intake-air temperature. In such a case, in the leading edge cover member 10a and the composite blade 20a, since the hard metallic reinforcement layer 19a having the high HV hardness value is included on the surface side of the metallic reinforcement layer 14a, the degree of fitness with the leading edge area 23a as a property on the composite blade 20a side is hardly affected.

As illustrated in FIG. 3, the metallic reinforcement layer 14a preferably includes an auxiliary metallic reinforcement layer 18a formed of a soft metal that is provided so as to be in contact with a surface on a side of the metallic reinforcement layer 14a on which the composite cover base material 11a is provided. In addition, the auxiliary metallic reinforcement layer 18a is preferably the Cu plating layer or the pure Ni plating layer. In such a case, in the leading edge cover member 10a and the composite blade 20a, the auxiliary metallic reinforcement layer 18a is made of the soft metal having the low HV hardness value of 300 or lower, and thus is soft and highly ductile. Accordingly, a shear strain generated on a boundary surface between the composite cover base material 11a and the metallic reinforcement layer 14a is reduced, and thereby, an adhesive strength can increase between the composite cover base material 11a and the metallic reinforcement layer 14a.

When the leading edge cover member 10a includes the electrical insulation layer 17a, and the metallic reinforcement layer 14a includes the auxiliary metallic reinforcement layer 18a and the hard metallic reinforcement layer 19a, the electrical insulation layer 17a, the auxiliary metallic reinforcement layer 18a, and the hard metallic reinforcement layer 19a are laid up in this order from the composite cover base material 11a toward the outside, as illustrated in FIG. 3. Laying up the layers in the above-described order allows the leading edge cover member 10a to suitably exert the above-described properties of the electrical insulation layer 17a, the auxiliary metallic reinforcement layer 18a, and the hard metallic reinforcement layer 19a.

The boundary surface on the metallic reinforcement layer 14a side of the composite cover base material 11a preferably has an arithmetic mean roughness value of 1 μm to 10 μm inclusive. Specifically, the boundary surface on the metallic reinforcement layer 14a side of the composite cover base material 11a is preferably subjected to blast processing, such as sanding, so as to be processed to have an arithmetic mean roughness value within the above-described range. In such a case, in the leading edge cover member 10a and the composite blade 20a, the arithmetic mean roughness of the boundary surface between the composite cover base material 11a and the metallic reinforcement layer 14a generates an anchor effect on the boundary surface, and thereby, the adhesive strength can increase between the composite cover base material 11a and the metallic reinforcement layer 14a.

Since the leading edge cover member 10a and the composite blade 20a have the configurations described above, a part of the leading edge cover member 10a provided to the leading edge area 23a of the composite blade body 21a in a bonding manner can be constituted by the composite material that is lightweight and has good workability, and the outside part of the leading edge cover member 10a serving as a part on the airflow upstream side thereof can be constituted by the metal that has the high corrosion resistivity and the high fatigue strength. Accordingly, the leading edge cover member 10a and the composite blade 20a are suitable to be used for the composite blade body 21a used in the industrial gas turbine compressor as the countermeasure against the water droplet erosion.

A composite blade 20b serves as a second example of the detailed configuration examples of the composite blade 20, and, as illustrated in FIG. 5, is obtained by changing the configuration of the composite blade 20a such that an outer surface of a boundary between the composite cover base material 11a and the metallic reinforcement layer 14a is formed as a smooth surface without any step, and such that an outer surface of a boundary between the composite blade body 21a and the leading edge cover member 10a is formed as a smooth surface without any step. The other configuration of the composite blade 20b is the same as that of the composite blade 20a, and therefore, detailed description thereof will not be made.

In the description of the composite blade 20b serving as the second example of the detailed configuration examples of the composite blade 20, for convenience of description, in the specification and the drawings, components are denoted by reference numerals different from those in the explanation of the composite blade 20a serving as the first example of the detailed configuration examples of the composite blade 20. Specifically, configuration elements corresponding to the leading edge cover member 10a, the composite cover base material 11a, the end part 12a, the metallic reinforcement layer 14a, the end part 15a, the adhesive layer 16a, the composite blade body 21a, the leading edge 22a, the leading edge area 23a, the direction Ca, the tangent line Ta, and the angle θa in the composite blade 20a are respectively denoted as a leading edge cover member 10b, a composite cover base material 11b, an end part 12b, a metallic reinforcement layer 14b, an end part 15b, an adhesive layer 16b, a composite blade body 21b, a leading edge 22b, a leading edge area 23b, a direction Cb, a tangent line Tb, and an angle θb in the composite blade 20b.

As illustrated in FIG. 5, a step part 24b is formed on the leading edge area 23b of the composite blade body 21b, the step part 24b having such a shape that the composite cover base material 11b of the leading edge cover member 10b is fitted. The depth of the step part 24b in a direction along the blade thickness direction is equal to the sum of the thickness of the composite cover base material 11b at the end part 12b thereof and the thickness of the adhesive layer 16b, and the area of a surface of a deepened part along the blade longitudinal direction and the blade width direction is equal to the area of the composite cover base material 11b. With this configuration, an outer surface of a boundary between the leading edge area 23b of the composite blade body 21b and the composite cover base material 11b of the leading edge cover member 10b, that is, a part including the end part 12b is formed as a smooth surface without any step. In the case of a configuration not including the adhesive layer 16b, the step part 24b is formed such that the depth thereof in the direction along the blade thickness direction is equal to the thickness of the composite cover base material 11b at the end part 12b thereof.

When the leading edge area 23b of the composite blade body 21b is formed by laying up composite layers, the shape of, for example, the depth, of the step part 24b can be accurately formed by controlling, for example, the thickness and number of the laid-up composite layers.

As described above, in the leading edge cover member 10b and the composite blade 20b, since the outer surface of the boundary between the leading edge area 23b and the composite cover base material 11b is formed as the smooth surface without any step, the composite blade 20b can be restrained from decreasing in aerodynamic efficiency.

As illustrated in FIG. 5, a step part 13b having a shape fitted to the metallic reinforcement layer 14b of the leading edge cover member 10b is formed on the composite cover base material 11b of the leading edge cover member 10b. The depth of the step part 13b in the direction along the blade thickness direction is equal to the thickness of the metallic reinforcement layer 14b at the end part 15b thereof, and the area of a surface of a deepened part along the blade longitudinal direction and the blade width direction is equal to the area of the metallic reinforcement layer 14b. When the same electrical insulation layer as the above-described electrical insulation layer 17a is provided, the step part 13b is formed to be deeper by the thickness of the electrical insulation layer. With this configuration, an outer surface of a boundary between the composite cover base material 11b and the metallic reinforcement layer 14b is formed as a smooth surface without any step.

When the composite cover base material 11b of the leading edge cover member 10b is formed by laying up composite layers, the shape of, for example, the depth, of the step part 13b can be accurately formed by controlling, for example, the thickness and number of the laid-up composite layers.

As described above, in the leading edge cover member 10b and the composite blade 20b, since the outer surface of the boundary between the composite cover base material 11b and the metallic reinforcement layer 14b is formed as the smooth surface without any step, the composite blade 20b can be restrained from decreasing in aerodynamic efficiency.

Since the leading edge cover member 10b and the composite blade 20b have the configurations described above, the same operational advantages as those of the leading edge cover member 10a and the composite blade 20a are obtained in addition to the above-described operational advantages.

A composite blade 20c serves as a third example of the detailed configuration examples of the composite blade 20, and, as illustrated in FIG. 6, is obtained by changing the configuration of the composite blade 20b such that a primer layer 18c containing palladium catalytic particles is formed on a boundary surface on the metallic reinforcement layer 14b side of the composite cover base material 11b. The other configuration of the composite blade 20c is the same as that of the composite blade 20b, and therefore, detailed description thereof will not be made.

In the description of the composite blade 20c in the third example of the detailed configuration examples of the composite blade 20, for convenience of description, in the specification and the drawings, components are denoted by reference numerals different from those in the explanation of the composite blade 20b serving as the second example of the detailed configuration examples of the composite blade 20. Specifically, configuration elements corresponding to the leading edge cover member 10b, the composite cover base material 11b, the end part 12b, the step part 13b, the metallic reinforcement layer 14b, the end part 15b, the adhesive layer 16b, the composite blade body 21b, the leading edge 22b, the leading edge area 23b, the step part 24b, the direction Cb, the tangent line

Tb, and the angle θb in the composite blade 20b are respectively denoted as a leading edge cover member 10c, a composite cover base material 11c, an end part 12c, a step part 13c, a metallic reinforcement layer 14c, an end part 15c, an adhesive layer 16c, a composite blade body 21c, a leading edge 22c, a leading edge area 23c, a step part 24c, a direction Cc, a tangent line Tc, and an angle θc in the composite blade 20c.

As illustrated in FIG. 6, the primer layer 18c is formed with a uniform thickness on an area of an outer surface of the composite cover base material 11c in which the step part 13c is formed. The metallic reinforcement layer 14c is formed on the area of the outer surface of the composite cover base material 11c in which the step part 13c is formed with the primer layer 18c interposed therebetween. In this case, in the leading edge cover member 10c and the composite blade 20c, the palladium catalytic particles contained in the primer layer 18c can increase the adhesive strength between the composite cover base material 11c and the metallic reinforcement layer 14c, and, in addition, the aerodynamic performance of the composite blade 20c can be improved by smoothing of the metallic reinforcement layer 14c. In particular, in the leading edge cover member 10c and the composite blade 20c, the metallic reinforcement layer 14c is preferably formed by the metallic plating process because, in that case, the palladium catalytic particles facilitate the formation of the metallic reinforcement layer 14c to have high adhesive strength and to be smooth.

The primer layer 18c preferably contains a resin, such as an epoxy resin, in addition to the palladium catalytic particles. The primer layer 18c more preferably contains a component of the resin contained in the composite cover base material 11c. In this case, in the leading edge cover member 10c and the composite blade 20c, the resin contained in the primer layer 18c can further increase the adhesive strength between the composite cover base material 11c and the metallic reinforcement layer 14c.

As a result of the formation of the primer layer 18c, the depth of the step part 13c in the direction along the blade thickness direction differs from that of the step part 13b. The depth of the step part 13c in the direction along the blade thickness direction is equal to the sum of the thickness of the metallic reinforcement layer 14c at the end part 15c thereof and the thickness of the primer layer 18c. When the same electrical insulation layer as the above-described electrical insulation layer 17a is provided, the step part 13c is formed to be deeper by the thickness of the electrical insulation layer.

Since the leading edge cover member 10c and the composite blade 20c have the configurations described above, the same operational advantages as those of the leading edge cover member 10b and the composite blade 20b are obtained in addition to the above-described operational advantages.

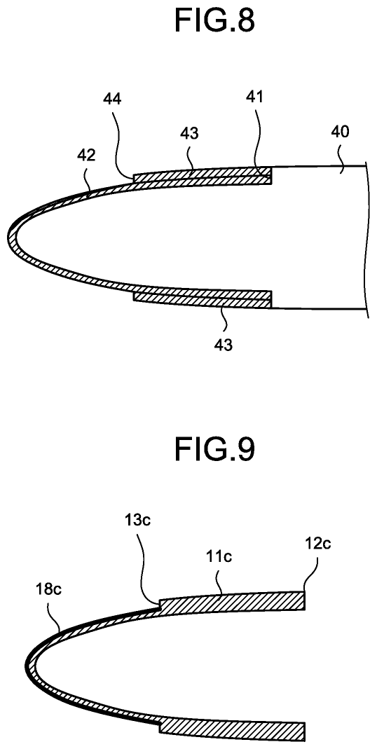

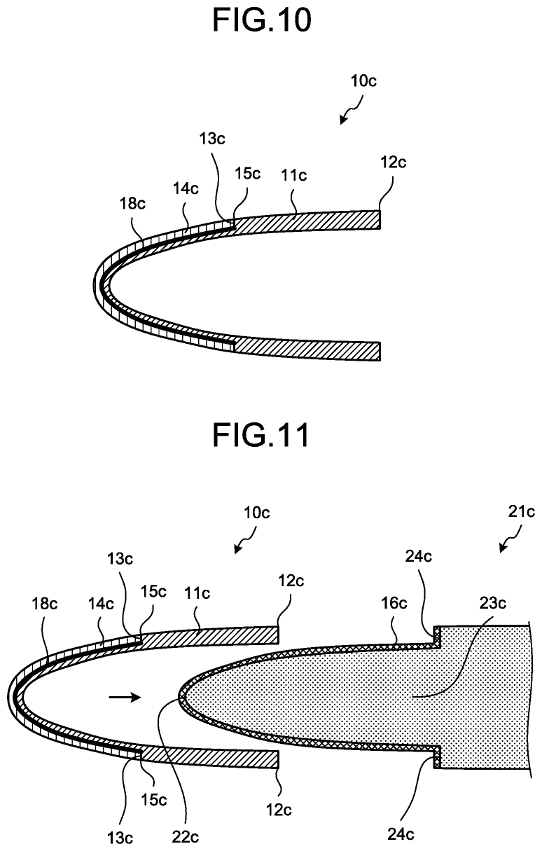

FIG. 7 is a flowchart illustrating a method of manufacturing the leading edge cover member and the composite blade according to the embodiment. FIG. 8 is an explanatory diagram explaining a composite cover base material forming step S12 in FIG. 7. FIG. 9 is an explanatory diagram explaining one stage of a metallic reinforcement layer forming step S13 in FIG. 7. FIG. 10 is an explanatory diagram explaining the next one stage of the metallic reinforcement layer forming step S13 in FIG. 7. FIG. 11 is an explanatory diagram explaining a bonding step S14 in FIG. 7. As an example of the method of manufacturing the leading edge cover member 10 and the composite blade 20 according to the embodiment, the following describes, using FIGS. 7 to 11, the method of manufacturing the leading edge cover member 10c and the composite blade 20c that have the most complicated configurations among the three examples describe above. As illustrated in FIG. 7, the method of manufacturing the leading edge cover member 10 and the composite blade 20 according to the embodiment includes a male die preparation step S11, the composite cover base material forming step

S12, the metallic reinforcement layer forming step S13, and the bonding step S14.

The male die preparation step S11 is a step of preparing a male die 40 that has a shape of the leading edge area 23c of the composite blade body 21c (refer to FIG. 8). The male die 40 can be prepared by forming a material of the male die 40 using an engineering drawing for the leading edge area 23c of the composite blade body 21c. The male die 40 can also be prepared by creating a female die using the leading edge areas 23c of the composite blade bodies 21c having shapes slightly different from one another, and using this female die to form the material of the male die 40. The male die 40 can also be prepared using the leading edge area 23c separated from the composite blade body 21c. As illustrated in FIG. 8, a step part 41 is formed on the male die 40, the step part 41 having the same shape as that of the step part 24c formed on the leading edge area 23c of the composite blade body 21c.

The composite cover base material forming step S12 is a step of forming the composite cover base material 11c of the leading edge cover member 10c by laying up the prepregs of the composite material containing the reinforcement fibers and the resin on the male die 40 prepared at the male die preparation step S11, and curing the laid-up prepregs. At the composite cover base material forming step S12, first, as illustrated in FIG. 8, a prepreg 42 having a first thickness just fittable with the step part 41 is laid up. At the composite cover base material forming step S12, subsequently, as illustrated in FIG. 8, a prepreg 43 having a second thickness is laid up on an area of the prepreg 42 on which the metallic reinforcement layer 14c is not formed at the metallic reinforcement layer forming step S13 (to be described later), that is, on an area of the prepreg 42 externally exposed so as to surround the metallic reinforcement layer 14c. At the composite cover base material forming step S12, the sum of the first thickness and the second thickness is made equal to the thickness of the composite cover base material 11c, and the second thickness is made equal to the depth of the step part 13c. In this way, at the composite cover base material forming step S12, a step part 44 having the same depth as that of the step part 13c is formed between the prepreg 42 and the prepreg 43.

At the composite cover base material forming step S12, a composite material preferably used in the composite cover base material 11c is preferably used for the prepreg 42 and the prepreg 43. In particular, at the composite cover base material forming step S12, the reinforcement fibers contained in the prepreg 42 and the prepreg 43 are preferably arranged along a direction of 30 degrees to 60 degrees inclusive, and more preferably arranged along a direction of 45 degrees, with respect to a direction of the male die 40 that corresponds to the blade longitudinal direction of the composite blade body 21c. In this case, the reinforcement fibers can be easily deformed to fit well along the male die 40. At the composite cover base material forming step S12, as the shape of the outer surface of the male die 40 is more complicated, the effect of the easy deformation and the well-fitting of the reinforcement fibers along the male die 40 is more significant.

At the composite cover base material forming step S12, the male die 40 with the prepreg 42 and the prepreg 43 laid up thereon is heated at an appropriate temperature to cure the resin contained in the prepreg 42 and the prepreg 43 to form the composite cover base material 11c. At the composite cover base material forming step S12, the resin contained in the prepreg 42 and the prepreg 43 may be cured from the softened state into the semi-cured state or the cured state, or may be cured from the semi-cured state into the cured state. When the resin contained in the prepreg 42 and the prepreg 43 is cured into the semi-cured state at the composite cover base material forming step S12, the degree of cure defined as a mass percentage of the resin in the cured state with respect to the whole resin is preferably from 20% to 50% inclusive. In this case, the adhesive strength between the composite cover base material 11c and the composite blade body 21c can be increased at the bonding step S14 (to be described later).

At the composite cover base material forming step S12, the composite cover base material 11c is formed using the male die 40 to fit the prepreg 42 and the prepreg 43 to the male die 40. Accordingly, a variation in shape of the composite cover base material 11c can be reduced.

By undergoing the composite cover base material forming step S12, the prepreg 42 and the prepreg 43 are formed into the composite cover base material 11c; end parts of the prepreg 42 and the prepreg 43 are aligned and laid up to be the end part 12c; and the step part 44 between the prepreg 42 and the prepreg 43 is formed into the step part 13c.

At the composite cover base material forming step S12, the same electrical insulation layer as the above-described electrical insulation layer 17a is preferably formed on the area of the outer surface of the composite cover base material 11c in which the step part 13c is formed. In this case, at the composite cover base material forming step S12, the composite cover base material 11c and the electrical insulation layer are preferably simultaneously cured to be formed. At the metallic reinforcement layer forming step S13, the materials described above in the description of the leading edge cover member 10a and the composite blade 20a are preferably used in the electrical insulation layer.

The metallic reinforcement layer forming step S13 is a step of forming the metallic reinforcement layer 14c on at least a part of the outside of the composite cover base material 11c that has been formed at the composite cover base material forming step S12. At the metallic reinforcement layer forming step S13, first, the composite cover base material 11c formed at the composite cover base material forming step S12 is removed from the male die 40.

At the metallic reinforcement layer forming step S13, subsequently, as illustrated in FIG. 9, the primer layer 18c having the uniform thickness is applied to and formed on the area of the outer surface of the composite cover base material 11c in which the step part 13c is formed. At the metallic reinforcement layer forming step S13, if the same electrical insulation layer as the above-described electrical insulation layer 17a has been formed on this area, the primer layer 18c is formed on this area with the electrical insulation layer interposed therebetween.

At the metallic reinforcement layer forming step S13, as illustrated in FIG. 10, the metallic reinforcement layer 14c is further formed on the primer layer 18c that has been formed. At the metallic reinforcement layer forming step S13, the metallic reinforcement layer 14c is preferably formed by the metallic plating process. In this case, the area on which the primer layer 18c has been formed serves as a surface to be plated with the metal, and the palladium catalytic particles contained in the primer layer 18c facilitate the formation of the metallic reinforcement layer 14c to have high adhesive strength and to be smooth.

At the metallic reinforcement layer forming step S13, it is preferable to form the same auxiliary metallic reinforcement layer as the above-described auxiliary metallic reinforcement layer 18a on the composite cover base material 11c side, and then form the same hard metallic reinforcement layer as the above-described hard metallic reinforcement layer 19a on the surface side. Specifically, at the metallic reinforcement layer forming step S13, it is preferable to first form the Cu plating layer or the pure Ni plating layer using an electrolytic Cu plating process or a pure Ni plating process in order to form the same auxiliary metallic reinforcement layer as the above-described auxiliary metallic reinforcement layer 18a on the primer layer 18c that has been formed, and then form the hard Cr plating layer using an electrolytic hard Cr plating process or form the Ni alloy plating layer using the electroless Ni alloy plating process in order to form the same hard metallic reinforcement layer as the above-described hard metallic reinforcement layer 19a.

At the metallic reinforcement layer forming step S13, the metallic reinforcement layer 14c is not directly formed on the leading edge area 23c of the composite blade body 21c, but is formed on the composite cover base material 11c that is to be bonded to the leading edge area 23c of the composite blade body 21c at the bonding step S14 (to be described later). Therefore, at the metallic reinforcement layer forming step S13, if the metallic reinforcement layer 14c is formed by the metallic plating process, a relatively small metallic plating bath capable of immersing the composite cover base material 11c smaller than the composite blade body 21c may only be used instead of using a larger metallic plating bath capable of immersing the composite blade body 21c having a larger size. Accordingly, the metallic reinforcement layer forming step S13 can form the metallic reinforcement layer 14c using relatively small equipment. As a result, cost for forming the metallic reinforcement layer 14c can be significantly reduced, and the metallic reinforcement layer 14c can be improved in quality. If electrolytic plating process is performed at the metallic reinforcement layer forming step S13, an area for mounting an electrode can be easily ensured by, for example, forming the composite cover base material 11c to be slightly longer in advance.

At the metallic reinforcement layer forming step S13, the metallic reinforcement layer 14c can also be formed using vacuum processing, such as vapor deposition or sputtering. Also in such a case, in the same way as in the above-described case of forming the metallic reinforcement layer 14c using the metallic plating process, it is preferable to form the same auxiliary metallic reinforcement layer as the above-described auxiliary metallic reinforcement layer 18a, and then form the same hard metallic reinforcement layer as the above-described hard metallic reinforcement layer 19a. Also in such a case, in the same way as in the above-described case of forming the metallic reinforcement layer 14c using the metallic plating process, a relatively small vacuum chamber may only be used. As a result, the cost for forming the metallic reinforcement layer 14c can be significantly reduced, and the metallic reinforcement layer 14c can be improved in quality.

At the metallic reinforcement layer forming step

S13, the composite cover base material 11c that is curved in a U-shape may be opened into an I-shape, and then, the metallic reinforcement layer 14c may be formed. In this case, for example, the film thickness of, for example, the metallic plating or the metallic vapor deposition of the metallic reinforcement layer 14c formed at the metallic reinforcement layer forming step S13 is less likely to be biased by the shape of a curved part of the composite cover base material 11c.

At the metallic reinforcement layer forming step S13, as illustrated in FIG. 10, the metallic reinforcement layer 14c is formed with a thickness obtained by subtracting the thickness of the primer layer 18c and the thickness of the same electrical insulation layer as the above-described electrical insulation layer 17a from the depth of the step part 13b. Accordingly, at the metallic reinforcement layer forming step S13, an outer surface of a boundary between the composite cover base material 11c and the metallic reinforcement layer 14c can be formed as a smooth surface without any step.

By undergoing the metallic reinforcement layer forming step S13, the leading edge cover member 10c including the composite cover base material 11c and the metallic reinforcement layer 14c is obtained.

The bonding step S14 is a step of fitting and bonding the leading edge cover member 10c obtained by undergoing the steps up to the metallic reinforcement layer forming step S13 to the composite blade body 21c. At the bonding step S14, first, the adhesive layer 16c is formed by applying an adhesive to the step part 24c that has been formed on the leading edge area 23c of the composite blade body 21c. At the bonding step S14, subsequently, as illustrated in FIG. 11, the composite blade body 21c with the adhesive layer 16c formed thereon is covered with the leading edge cover member 10c, with a side thereof on which the metallic reinforcement layer 14c is formed facing outward. At the bonding step S14, furthermore, the adhesive layer 16c is cured to bond the leading edge cover member 10c to the composite blade body 21c. As a result, the composite blade 20c including the leading edge cover member 10c and the composite blade body 21c is obtained.

At the bonding step S14, the leading edge cover member 10c and the composite blade body 21c may be bonded together so as to eventually obtain a configuration not including the adhesive layer 16c; that is, for example, the leading edge cover member 10c and the composite blade body 21c may be bonded together by curing the resin contained in the leading edge cover member 10c or the leading edge area 23c from the semi-cured state into the cured state, or may be bonded together using an adhesive having the same components as those of the resin contained in the leading edge cover member 10c or the leading edge area 23c.

To obtain the leading edge cover member 10b and the composite blade 20b instead of the leading edge cover member 10c and the composite blade 20c, the processing of forming the primer layer 18c at the metallic reinforcement layer forming step S13 only needs to be changed to the processing of applying the blast processing, such as sanding, to the surface of the composite cover base material 11b so as to have the arithmetic mean roughness value of 1 μm to 10 μm inclusive in the above-described method of manufacturing the leading edge cover member and the composite blade according to the embodiment.

To obtain the leading edge cover member 10a and the composite blade 20a instead of the leading edge cover member 10c and the composite blade 20c, it is only necessary to prepare the male die without the step part 41 formed thereon instead of preparing of the male die 40 with the step part 41 formed thereon at the male die preparation step S11, and to form the composite cover base material 11a without the step part 13c by laying up, for example, the prepregs 42 and 43 so as not to form the step part 44 at the composite cover base material forming step S12, in addition to changing the processing from that of obtaining the leading edge cover member 10c and the composite blade 20c to that of obtaining the leading edge cover member 10b and the composite blade 20b in the above-described method of manufacturing the leading edge cover member and the composite blade according to the embodiment.

Since the method of manufacturing the leading edge cover member and the composite blade according to the embodiment has the configuration described above, the part of the leading edge cover member 10a, 10b, or 10c provided to the leading edge area 23a, 23b, or 23c of the composite blade body 21a, 21b, or 21c in a bonding manner can be constituted by the composite material that is lightweight and has good workability, and the outside part of the leading edge cover member 10a, 10b, or 10c serving as the part on the airflow upstream side thereof can be constituted by the metal that has the high corrosion resistivity and the high fatigue strength. Accordingly, the leading edge cover member 10a, 10b, or 10c and the composite blade 20a, 20b, or 20c can be obtained that are suitable to be used for the composite blade body 21a, 21b, or 21c used in the industrial gas turbine compressor as the countermeasure against the water droplet erosion.

In the method of manufacturing the leading edge cover member and the composite blade according to the embodiment, the stage of removing the composite cover base material 11a, 11b, or 11c from the male die 40 is not limited to the stage before the metallic reinforcement layer 14c is formed at the metallic reinforcement layer forming step S13, and may be any stage after the composite cover base material 11a, 11b, or 11c is formed at the composite cover base material forming step S12 until immediately before the composite blade body 21a, 21b, or 21c is covered with the composite cover base material 11a, 11b, or 11c at the bonding step S14. For example, if the composite cover base material 11a, 11b, or 11c is not removed from the male die 40 until immediately before the composite blade body 21a, 21b, or 21c is covered at the bonding step S14, the leading edge cover member 10a, 10b, or 10c and the male die 40 can be handled as a leading edge cover member unit that includes the leading edge cover member 10a, 10b, or 10c and the male die 40 provided, on an outside thereof, with the leading edge cover member 10a, 10b, or 10c. The leading edge cover member unit has the above-described configuration, and accordingly, can be handled, for example, carried, while appropriately maintaining the shape of the leading edge cover member 10a, 10b, or 10c using the male die 40.

### REFERENCE SIGNS LIST

10, 10a, 10b, 10c Leading edge cover member
11a, 11b, 11c Composite cover base material
12a, 12b, 12c, 15a, 15b, 15c End part
13b, 13c, 24b, 24c, 41, 44 Step part
14a, 14b, 14c Metallic reinforcement layer
16a, 16b, 16c Adhesive layer
17a Electrical insulation layer
18a Auxiliary metallic reinforcement layer
18c Primer layer
19a Hard metallic reinforcement layer
20, 20a, 20b, 20c Composite blade
21, 21a, 21b, 21c Composite blade body
22, 22a, 22b, 22c Leading edge
23, 23a, 23b, 23c Leading edge area
26 Composite blade support member
30 Curve
31, 32, 33 Point
40 Male die
42, 43 Prepreg

1. A leading edge cover member provided on an outside of a leading edge area including a leading edge serving as a part on an airflow upstream side of a composite blade body containing reinforcement fibers and a resin, the leading edge cover member comprising:
a composite cover base material that contains reinforcement fibers and a resin, and is provided to the outside of the leading edge area in a bonding manner; and
a metallic reinforcement layer formed on at least a part of an outside of the composite cover base material.

2. The leading edge cover member according to claim 1, wherein
the composite cover base material has a thickness at a ratio of 2% to 30% inclusive with respect to a leading edge radius of the composite blade body or half the minor axis of the composite blade body over the whole blade length of the composite blade body, and
the metallic reinforcement layer has a thickness of 5 μm to 100 μm inclusive.

3. The leading edge cover member according to claim 1, wherein the thickness of the metallic reinforcement layer is equal to or smaller than the thickness of the composite cover base material.

4. The leading edge cover member according to claim 1, wherein, in the composite cover base material, the reinforcement fibers contained in the composite cover base material are arranged along a direction of 30 degrees to 60 degrees inclusive with respect to a blade longitudinal direction of the composite blade body.

5. The leading edge cover member according to claim 1, wherein the composite cover base material is formed by laying up thin-film prepregs of a carbon fiber reinforced plastic or a glass fiber reinforced plastic.

6. The leading edge cover member according to claim 1, wherein, in the composite cover base material, the reinforcement fibers contained in the composite cover base material are high-modulus resin fibers.

7. The leading edge cover member according to claim 1, comprising an electrically insulative electrical insulation layer provided so as to be in contact with a surface on a side of the composite cover base material on which the metallic reinforcement layer is provided.

8. The leading edge cover member according to claim 7, wherein the electrical insulation layer is an insulating fiberglass reinforced plastic layer.

9. The leading edge cover member according to claim 1, wherein the metallic reinforcement layer includes a hard metallic reinforcement layer that is provided on a surface side of the metallic reinforcement layer and is formed of a hard metal or a superhard metal.

10. The leading edge cover member according to claim 9, wherein the hard metallic reinforcement layer is a hard chromium (Cr) plating layer or a nickel (Ni) alloy plating layer.

11. The leading edge cover member according to claim 1, wherein the metallic reinforcement layer includes an auxiliary metallic reinforcement layer formed of a soft metal that is provided so as to be in contact with a surface on a side of the metallic reinforcement layer on which the composite cover base material is provided.

12. The leading edge cover member according to claim 11, wherein the auxiliary metallic reinforcement layer is a copper (Cu) plating layer or a pure Ni plating layer.

13. The leading edge cover member according to claim 1, wherein a boundary surface on the metallic reinforcement layer side of the composite cover base material has an arithmetic mean roughness value of 1 μm to 10 μm inclusive.

14. The leading edge cover member according to claim 1, wherein a primer layer containing palladium catalytic particles is formed on a boundary surface on the metallic reinforcement layer side of the composite cover base material.

15. The leading edge cover member according to claim 1, wherein an outer surface of a boundary between the composite cover base material and the metallic reinforcement layer is formed as a smooth surface without any step.

16. A leading edge cover member unit comprising:
the leading edge cover member according to claim 1; and
a male die that is provided, on an outside thereof, with the leading edge cover member, and has a shape of the leading edge area of the composite blade body.

17. A composite blade comprising:
the leading edge cover member according to claim 1; and
the composite blade body provided, on the outside of the leading edge area thereof, with the leading edge cover member.

18. The composite blade according to claim 17, wherein an outer surface of a boundary between the composite blade body and the leading edge cover member is formed as a smooth surface without any step.

19. A method of manufacturing a leading edge cover member provided on an outside of a leading edge area including a leading edge serving as a part on an airflow upstream side of a composite blade body, the method comprising:
forming a composite cover base material of a leading edge cover member by laying up prepregs containing reinforcement fibers and a resin on a male die having a shape of the leading edge area of the composite blade body, and curing the laid-up prepregs; and
forming the leading edge cover member by forming a metallic reinforcement layer on at least a part of an outside of the composite cover base material that has been formed at the composite cover base material forming step.

20. A method of manufacturing a composite blade comprising:
the method of manufacturing a leading edge cover member according to claim 19; and
fitting and bonding the leading edge cover member with the metallic reinforcement layer formed thereon to the composite blade body.
